(19) United States
(12) Patent Application Publication
(10) Pub. No.: US 2013/0006842 A1
(43) Pub. Date: Jan. 3, 2013

(54) SYSTEM AND METHOD FOR CREATING AND FACILITATING THE TRADING OF A FOREIGN EXCHANGE DEFERRED SPOT PRODUCT

(76) Inventor: Diwakar Jagannath, West New York, NJ (US)

(21) Appl. No.: 13/634,391

(22) PCT Filed: Mar. 10, 2011
(86) PCT No.: PCT/US11/27910

§ 371 Date: Sep. 12, 2012

Related U.S. Application Data
(60) Provisional application No. 61/313,326, filed on Mar. 12, 2010.

(51) Int. Cl. G06Q 40/04

(52) U.S. Cl. 705/37

(57) ABSTRACT

A computer implemented method and system for creating and facilitating the trading of a financial product. An order is requested by a first party for a first financial product from a second party, wherein the order is entered into an electronic computer trading system. An agreement is created by the second party with a third party to convert the first financial product into a second financial product. The first financial product is converted into the second financial product which is then cleared. The cleared second financial product is delivered to the second party and listed the on an exchange where it is traded. The first financial product may be a spot foreign exchange order that is converted, via an exchange of futures swaps, to the second financial product such as a foreign exchange deferred spot product. The financial product includes an interest rate pay/collect feature by way of Swap Points, which are expressed in terms of fractional parts of minimum price increments as a positive or negative number. A positive Swap Point reflects a credit for the Short Futures Position and a debit for the Long Futures position, and a negative Swap Point reflects a debit for the Short Futures Position and a credit for the Long Futures Position.

### CROSS REFERENCE TO RELATED APPLICATIONS

This application is a National Phase application claiming the benefit of International Application No, PCT/US11/27910, filed Mar. 10, 2011 that claims the benefit of and priority to U.S. Provisional Application No. 61/313,326, filed Mar. 12, 2010, both of which are incorporated herein by reference.

### BACKGROUND

The present disclosure relates generally to financial markets and derivative forms of financial products, and more particularly to a system and method for creating and facilitating the trading of a standardized foreign exchange deferred spot product, including a standardized foreign exchange deferred spot product having an interest rate carry feature.

### DESCRIPTION OF THE RELATED ART

The foreign exchange market (FX), such as Forex, or the like, is a worldwide decentralized over-the-counter (OTC) financial market for the trading of currencies. The price of one currency in terms of another is called an exchange rate. Financial centers around the world function as hubs of trading between a wide range of different types of buyers and sellers. The market itself does not have a central headquarters; rather the market is actually made up of a worldwide network of traders, connected by computers, networks, servers, telephone lines, the internet, or the like. The majority of all foreign exchange transactions are handled by three main centers of trading which include the United States, the United Kingdom, and Japan. The remaining transactions in the market occur elsewhere in the world such as Germany, France, Australia, Switzerland, Hong Kong, Singapore, or the like.

The purpose of the foreign exchange market is to assist international trade and investment. The foreign exchange market allows businesses to convert one currency to another foreign currency. For example, it permits a U.S. business to import European goods and pay in Euros, even though the business's income is in U.S. dollars. In a typical foreign exchange transaction a party purchases a quantity of one currency by paying a quantity of another currency. The FX market is fast paced, volatile and enormous—it is the largest market in the world where billions of dollars are traded each day.

The interbank market is an important segment of the FX market. The interbank market is a top-level FX market where banks exchange different currencies. The banks can either deal with one another directly, or through electronic brokering platforms. The currencies of most developed countries have floating exchange rates. These currencies do not have fixed values but, rather, values that fluctuate relative to other currencies. It is a wholesale market through which most currency transactions are channeled. It is mainly used for trading among bankers. The interbank market is unregulated and decentralized. There is no specific location or exchange where these currency transactions take place.

The FX market, unlike the stock market, does not have a physical central exchange like the NYSE, where currency exchange rates are made or set, by market makers. Rather, banks constantly quote a bid and ask price based on anticipated currency movements taking place and thereby make the market. These transactions cause the primary movement of currency prices. Other factors contributing to currency exchange rates include FX transactions made by smaller banks, hedge funds, companies, FX brokers, traders, or the like. Companies are typically involved in FX transactions because they need to pay for products and services supplied from other countries which use a different currency. FX traders on the other hand typically use FX transactions, of a much smaller volume with comparison to banks, to benefit from anticipated currency movements by buying low and selling at a higher price or vice versa. This is done through FX brokers who act as a mediator between a pool of traders and also between themselves and banks. Central banks, such as the Federal Reserve Bank of the United States, or the like, also play a role in setting currency exchange rates by altering interest rates. By increasing interest rates central banks stimulate traders to buy their currency as it provides a high return on investment and drives the value of the corresponding central bank's currency higher in comparison to other currencies.

Until the Commodity Futures Modernization Act of 2000 (CFMA), the OTC FX was a largely unregulated marketplace for retail investors. Although the service providers in the OTC FX market included many credible financial services firms, the OTC FX market was rife with fraudulent activities and operations. With limited oversight, retail investors had little choice, other than the exchange traded products which had little similarity to the industry wide interbank market.

After the CFMA, entities, such as firms, dealing in the retail OTC market were required to register with the United States Commodities Futures Trading Commission (CFTC) and become members of the National Futures Association (NFA). Although the barriers to entry were small (for example, minimum net capital requirements were less than 500,000 USD for futures commission merchants (FCM)), it brought about a process that allowed for oversight of the product, financial requirements, sales practices, and the like. In the ensuing eight years, there has been an evolution of the regulatory framework. Net capital requirements have been raised considerably (currently at 20,000,000 USD), trading best practices have been established, and sales solicitations have been monitored. Most importantly, however, enforcement has taken precedent and the number of cases brought against persons/entities has risen dramatically. Furthermore, in light of the higher financial requirements, the number of entities registered as Forex Deal Merchants (FDM) has shrunk from forty-five to less than fifteen today.

The current structure of the OTC FX market provides for two counterparties agreeing to exchange (swap) one currency pair for another at a specified rate. The trade is standardized in the following areas: each trade has a notional amount; each trade is an exchange of a single country's currency for another country's currency (e.g., US dollars versus Japanese Yen, etc.); each trade has standard settlement procedures; each trade has standardized pricing conventions; and profits and losses are updated on a real-time “tick-by-tick” basis.

The retail FX market uses all of the above standards, but has one important caveat: less than 1% of all transactions go to delivery. In other words, the retail FX market is strictly a speculative instrument where an individual investor enters into a bilateral transaction with a registered FDM. Although regulated by the NFA and CFTC, the FDM carries these OTC transactions on a non-segregated basis, meaning any default by the FDM gives the investor no priority standing in bankruptcy proceedings. This concern is further exacerbated by the fact that the FDM will offset its transaction in the same manner with another party or counterparty, such as a bank, or the like. Therefore, the client, such as an individual investor, has counterparty risk not only to the FDM, but also to the banks with which the FDM does business. This dislocation not only creates adverse repercussions throughout the banking community, but also directly throughout the retail investing public.

Thus, there is a need in the art for a standardized foreign exchange deferred spot product that may be traded in a cleared environment. There is also a need in the art for a method and system for creating and facilitating the trading of a foreign exchange deferred spot product in a cleared environment.

### SUMMARY

Accordingly, a computer implemented method for creating and facilitating the trading of a financial product is provided. An order is requested by a first party for a first financial product from a second party, wherein the order is entered into a electronic computer trading system. An agreement is created by the second party with a third party to convert the first financial product into a second financial product. The first financial product is converted into the second financial product which is then cleared. The cleared second financial product is delivered to the second party and listed the on an exchange where it is traded. The first financial product may be a spot foreign exchange order that is converted, via, an exchange of futures swaps, to the second financial product such as a foreign exchange deferred spot product.

Also provided is a computer implemented method for creating and facilitating the trading of a financial product. The method includes providing a computer server on which a financial product is selectively created and traded; and providing a computer interface in operable communication with the computer server, the computer interface enabling a user to enter an order for a financial product. The method also includes a customer entering a foreign exchange order into the computer server. The method also includes a futures commission merchant entering into an agreement with a national exchange which permits the foreign exchange order to be converted into a futures contract via an exchange of futures for swap. The method also includes converting the foreign exchange order into a futures contract via an exchange of futures for swap. The method also includes the futures contract being cleared through a national clearing house. The method also includes the national clearing house delivering the cleared futures contract to the futures commission merchant.

Also provided, is a computer system for creating and facilitating the trading of a financial product including a computer server on which a financial product is selectively created and traded and a computer interface in operable communication with the computer server which enables a user to enter an order for a financial product. The computer system enables a customer to enter a foreign exchange order into the computer server; a futures commission merchant to enter into an agreement with a national exchange which permits the foreign exchange order to be converted into a futures contract via an exchange of futures for swap; the foreign exchange order to be converted into a futures contract via an exchange of futures for swap; the futures contract to be cleared through a national clearing house; and the national clearing house to deliver the cleared futures contract to the futures commission merchant. The financial product may include an interest rate pay/collect feature by way of Swap Points, which are expressed in terms of fractional parts of minimum price increments as positive and negative numbers, which reflect debits and credits for the long and short positions accordingly. A Positive Swap Point reflects a Credit for the Short Futures Position and a Debit for the Long Futures position, and a Negative Swap Point reflects a Debit for the Short Futures Position and a Credit for the Long Futures Position.

An advantage of the present disclosure is that the clearing house provides greater financial security for customer funds. Another advantage is that there is a segregation requirement for customer funds. Another advantage is that there is greater oversight over FDM positions and market exposure. A further advantage is the ability to monitor for default risk between counterparties. Yet another advantage is the ability to better contain and control systemic risk. Still another advantage is the establishment of a marketplace with full standardized products. Still a further advantage is the establishment of dynamic margin policies. Yet another advantage is there is no delivery interference. Yet another advantage is improved market surveillance. Yet another advantage is the establishment of standard best practices. A further advantage is the establishment of clear jurisdiction and registration over industry participants. Still a further advantage is the ease of transition from OTC to clearing. Yet another advantage is participant demand (clients asking for security of funds). Still another advantage is product innovation creating new demand (no attrition due to regulatory arbitrage).

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is a flow chart of illustrating the method of creating and facilitating the trading of a foreign exchange deferred spot product, according to an exemplary embodiment.

FIG. 2 is a diagram of an electronic computer system for creating and facilitating the trading of a foreign exchange deferred spot product, according to an exemplary embodiment.

FIG. 3 is a diagram of an electronic computer system for creating and facilitating the trading of a foreign exchange deferred spot product, according to an alternate embodiment.

FIG. 4 is a chart illustrating contract specifications for XAU/USD Spot Gold Futures, according to an exemplary embodiment.

FIG. 5 is an exhibit illustrating a trading example for XAU/USD Spot Gold Futures, according to an exemplary embodiment.

FIG. 6 is an exhibit defining a daily interest calculation for trading XAU/USD Spot Gold Futures, according to an exemplary embodiment.

FIG. 7 is an exhibit detailing an algorithm for calculating a daily interest for trading XAU/USD Spot Gold Futures, according to an exemplary embodiment.

FIG. 8 is a chart illustrating contract specifications for EUR/USD Spot FX Futures as a direct quote currency, according to an exemplary embodiment.

FIG. 9 is an exhibit illustrating a trading example for EUR/USD Spot FX Futures as a direct quote currency, according to an exemplary embodiment.

FIG. 10 is an exhibit defining a daily interest calculation for trading EUR/USD Spot FX Futures as a direct quote currency, according to an exemplary embodiment.

FIG. 11 is an exhibit detailing an algorithm for calculating a daily interest for trading FUR/USD Spot FX Futures as a direct quote currency, according to an exemplary embodiment.

FIG. 12 is a chart illustrating contract specifications for USD/JPY Spot FX Futures as an indirect quote currency, according to an exemplary embodiment.

FIG. 13 is an exhibit illustrating a trading example for USD/SPY Spot FX Futures as an indirect quote currency, according to an exemplary embodiment.

FIG. 14 is an exhibit defining a daily interest calculation for trading USD/JPY Spot FX Futures as an indirect quote currency, according to an exemplary embodiment.

FIG. 15 is an exhibit detailing an algorithm for calculating a daily interest for trading USD/JPY Spot FX Futures as an indirect quote currency, according to an exemplary embodiment.

### DESCRIPTION

The present disclosure generally provides for a deferred spot foreign exchange futures product that generally mimics the spot foreign exchange market. The deferred spot foreign exchange futures product is standardized with underlying currency units and specifications that call for the daily pay and/or collect of accrued interest. The product is cleared through a national clearinghouse and listed on a national exchange where it maintains a unique trading symbol.

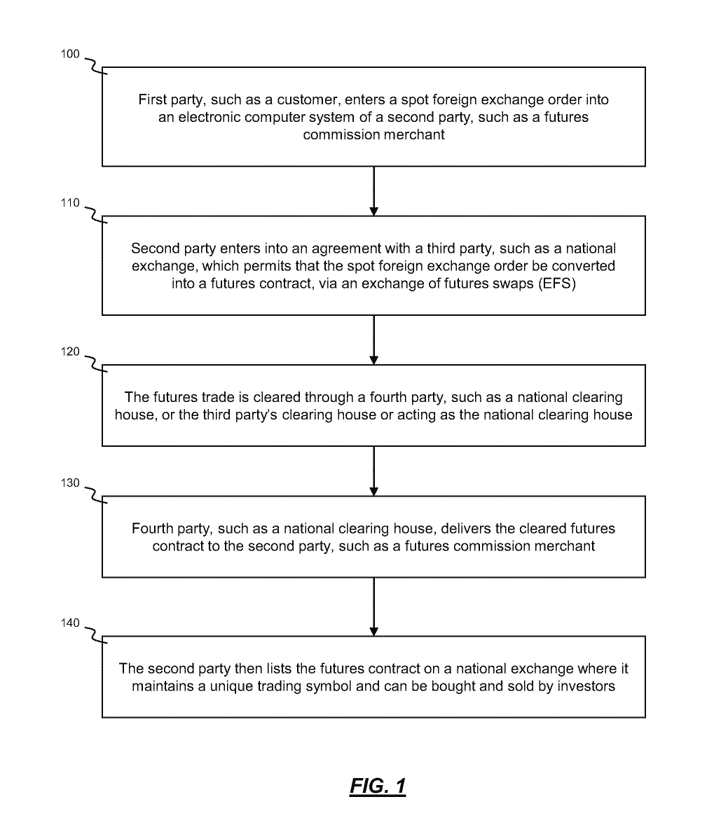

Referring now to FIG. 1, a method of creating and facilitating the trading of a foreign exchange deferred spot product, according to an exemplary embodiment, is shown. The method may involve a plurality of parties or entities including, but not limited to, a customer (e.g., buyer, seller, or the like), a futures commission merchant (FCM), a FDM, a bank, a national exchange, a national clearing house, or the like.

The methodology begins at step 100 where a first party submits or requests a spot foreign exchange order from a second party. The first party may be a customer, such as a retail investor, or the like. The second party may be a merchant, such as a FCM, or the like. For example, a customer such as a retail investor enters a spot foreign exchange order into a FCM's computerized system.

Next, the methodology proceeds to step 110 where the second party enters into an agreement with a third party who permits the spot foreign exchange order to be converted into a futures contract. The second party may be a merchant, such as a FCM, or the like. The third party may be a national exchange who makes the conversion via an exchange of futures for swaps (EFS).

The methodology then proceeds to step 120 where the order (futures contract) is cleared through a fourth party or the third party. In this step, the futures contract is cleared to settle the trade between the contracting parties. The fourth party may be a clearinghouse independent of the third party. The third party may be the national exchange of step 110 acting as a clearinghouse, a clearinghouse owned by the third party of step 110, or the like.

The methodology then proceeds to step 130 where the fourth party or third party acting as the clearinghouse delivers the cleared futures contract to the second party. The second party may be a merchant, such as a FCM, or the like.

The methodology then proceeds to step 140 where the second party lists the futures contract on a national exchange. Here, the futures contract maintains a unique trading symbol and can be bought and sold by investors.

Although the foregoing example is described with regards to utilization by a particular party or entity, such as an FCM, it is important to note that any of the parties and/or entities described herein may utilize the present innovation in the same, similar and/or analogous manner. For example, the party acting as FCM could be a FDM, a bank, or the like. Moreover, the number of parties in the methodology may be altered. For example, the first party and the third party may interact with each other directly; the third party may also act as the fourth party, or the like. It is also contemplated that the number and sequence of methodology steps may be altered, arranged, interchanged, or otherwise modified to encompass the spirit and scope of the innovation.

From the perspective of first party (customer) trading retail foreign exchange, there is no change to the existing business model which permits customers to trade spot foreign exchange. The first party (customer) still trades spot foreign exchange products, the second party (e.g., FCM) remains the initial counterparty, and the pricing seen by the first party (customer) remains intact. This process, however, provides for the second party (e.g., FCM) to utilize an exchange of futures for, or in connection with, a swap, or EFS to convert spot foreign exchange transactions into futures contracts.

The EFS consists of two discrete and related transactions that include a swap transaction and a futures transaction involving a contract between two parties. At the time the transaction is effected, the buyer and seller of the contract are, respectively, the seller and buyer of the swap agreement. The swap agreement component of the EFS transaction involves the economically equivalent foreign exchange swap instrument underlying the exchange-listed contract. This is comparable to the commonly known Exchange of Physical or “EFP” transactions. The manner in which the second party (e.g., FCM) will convert the spot foreign exchange transactions into futures contracts will be via the same reporting format used for EFPs. As such, a futures trade will be reported to the third party (e.g., a national exchange) who will generate the market data to the associated national clearing house (e.g., the third party, fourth party) and deliver it to the second party (e.g., FCM) accordingly. The data may also be reported to regulators as necessary.

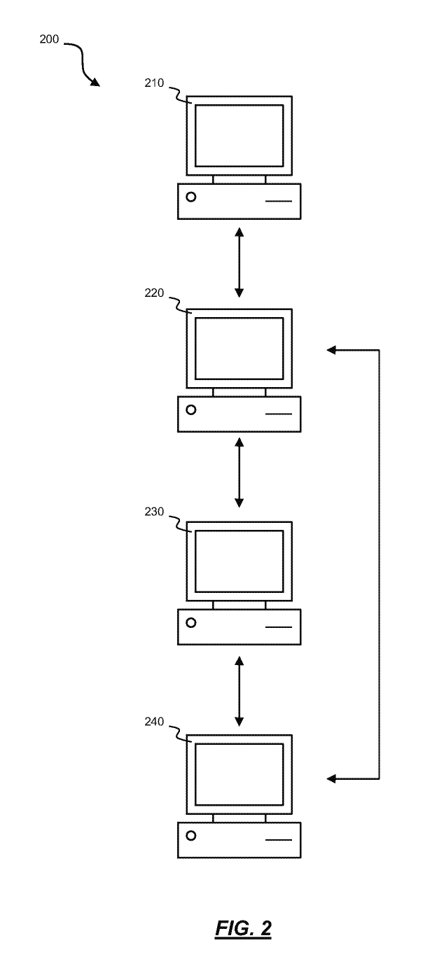

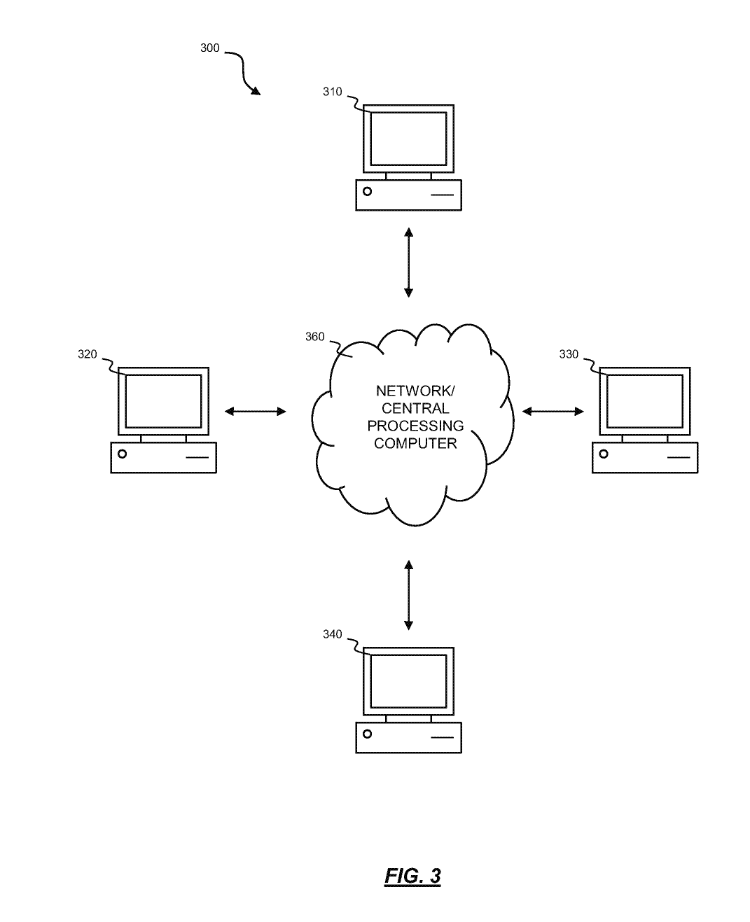

Referring now to FIGS. 2-3 and particularly FIG. 2, an electronic computer system 200 for creating and trading the deferred spot foreign exchange futures product of the present disclosure. In this example, the system includes a first party system 210, a second party system 220, a third party system 230 and a fourth party system 240. The first party system 210 is in bi-directional communication with second party system 220. The second party system 220 is in bi-directional communication with the first party system 210, the third party system 230, and the fourth party system 240. The third party system 230 is in bi-directional communication with the second party system 220 and the fourth party system 240. The fourth party system 240 is in bi-directional communication with the third party system 230 and the first party system 240.

Referring now to FIGS. 2-3 and particularly to FIG. 3, an electronic computer system 300 for creating and facilitating the trading of a foreign exchange deferred spot product, according to another exemplary embodiment, is shown. In this example, the system 300 includes a network and/or central processing device (e.g., computer system, or the like.) and/or server computer 360, a plurality of interconnected communication devices (e.g., computer systems, or the like) associated with various parties, such as the first party system 310, a second party system 320, a third party system 330, a fourth party system 340, or the like.

The central processing computer can provide control over the system and can perform any of the various processing services and/or functions described herein. The central processing computer may be a single computer or system of computers and/or may include any number or plurality of computers or computer systems which are utilized in conjunction with one another. The central processing computer can provide services for any of the other computers and/or computer systems described herein as being associated with any of the parties or entities involved, such as, individuals, buyers, sellers, clearinghouses, exchanges, banks, insurers, payers, brokers, agents, intermediaries, firms, and/or the like.

The devices (e.g., communication devices, computers, etc.) of any number of parties or entities can communicate and/or operate with, and operate in conjunction with, the central processing computer and/or any of the other computers and/or computer systems associated with any of the other individuals and/or entities which utilize and/or operate in conjunction with the present innovation.

The devices can be any computer or communication device, including, but not limited to, a personal computer, a home computer, a server computer, a network computer, a hand-held computer, a palmtop computer, a laptop computer, a personal communication device, a personal digital assistant (PDA), a telephone, a digital telephone, a television, an interactive television, a beeper, a pager, watch, and/or the like.

Each of the devices can transmit information to, as well as receive information from, any of the other devices described herein. In this regard, each of the devices can communicate with, process information from, and/or share data and/or information with, each other and/or any other device or devices described herein and/or utilized in conjunction with the present innovation. In this manner, data and/or information transfer between any of the devices can communicate with any other device or devices in a bi-directional manner.

Any of the devices of the system can communicate with one another, and/or be linked to one another, over a communication network, a telecommunication network, a telephone network, a line-connected network, a wireless communication network, and/or the like. Each of the devices can be linked with any other device or devices directly or indirectly directly or indirectly with one another so as to facilitate a direct or indirect bidirectional communication said respective devices.

The present innovation can be utilized or implemented on, and/or over, the Internet, and/or the World Wide Web (WWW). The present innovation can also utilize wireless Internet and/or World Wide Web services, equipment and/or devices. Any of the devices in the preferred can also include a web site or web sites associated therewith.

The present innovation can also be utilized with any appropriate communication network or system including, but not limited to, a communication network or system, local area network (LAN), wide area network (WAN), virtual private network (VPN), a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, and/or any other communication network or system, any combination of the above communication networks or systems, and/or the like.

Any of the devices can transmit data and/or information using TCP/IP, as well as any other Internet and/or World Wide Web, and/or communication, protocols. The system of the present innovation can also utilize electronic commerce technologies and security methods, techniques and technologies (e.g., encryption, firewalls, etc.), in any and/or all of the instances of data and/or information processing, and/or data and/or information transmission described herein.

The system can be a network computer or computer system, or any other communication device which can provide the functionality of and which can be utilized as a central processing computer such as an Internet server computer and/or a web site server computer. The central processing computer can include a central processing unit or CPU, such as, a microprocessor. The CPU can also be a microcomputer, a minicomputer, a macro computer, a mainframe computer, and/or the like, depending upon the application.

Any of the devices can include a random access memory device(s) (RAM), a read only memory device(s) (ROM), each of which can be connected to a CPU, a user input device, for entering data and/or commands into any of the devices, which includes any one or more of a keyboard, a scanner, printer, a user pointing device, such as, for example, a mouse, a touch pad, and/or an audio input device and/or a video input device, flash memory drive, and/or any device, electronic and/or otherwise which can be utilized for inputting and/or entering data and/or information, which input device(s) can also be connected to the CPU, Any of the devices can also include a display device for displaying data and/or information to a user or operator.

Any of the devices can also include a transmitter(s), for transmitting signals and/or data and/or information (e.g., modem, etc) to any one or more of the devices which may be utilized in conjunction with the present innovation, Any of the devices can also includes a receiver, for receiving signals and/or data and/or information from any one or more of the devices which may be utilized in conjunction with the present innovation.

Any of the devices can include a database(s) which contains data and/or information pertaining to the parties and/or entities who or which are serviced by the present innovation and/or who or which utilize the present innovation.

The database(s) can contain any and/or all of the information needed and/or required in order to perform any and/or all of the functions, services and/or operations described herein as being performed by the system and/or any of the devices. In this regard the database can contain data and/or information regarding and any other data and/or information regarding the individuals, buyers, sellers, clearinghouses, exchanges, banks, insurers, payers, brokers, agents, intermediaries, firms, financial products, exchange rates, currencies, securities, stocks, futures, commodities, or the like which would be needed and/or desired in order to perform any and/or all of the functions, services and/or operations described herein.

The system and method of the present innovation can be utilized in numerous preferred embodiments in order to provide a vast array of financial and financial-related services for any one or more of the various parties or entities described herein. While the embodiments may be described with regards to utilization by a particular party or entity, it is important to note that any of the parties and/or entities described herein may utilize the present novation in the same, similar and/or analogous manner.

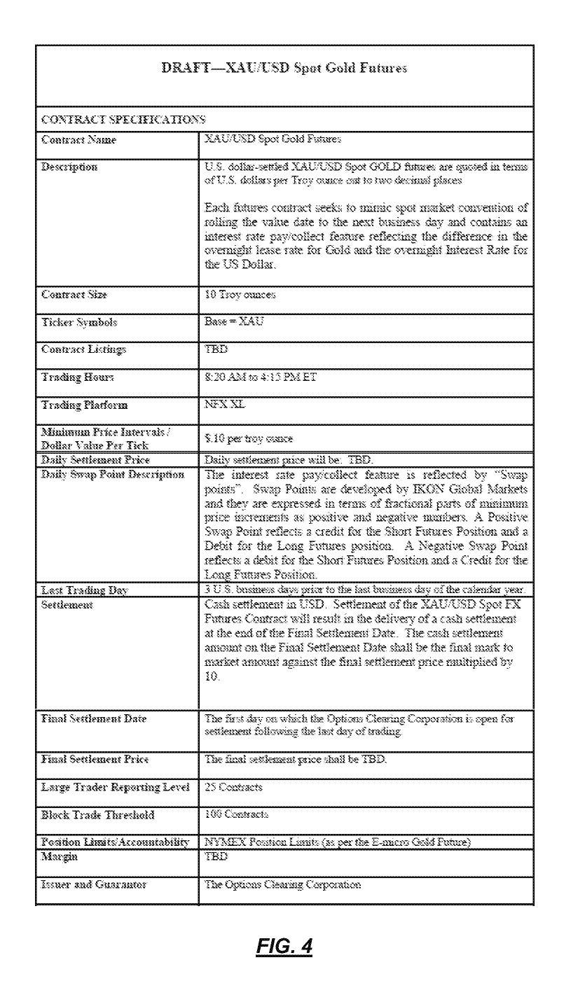

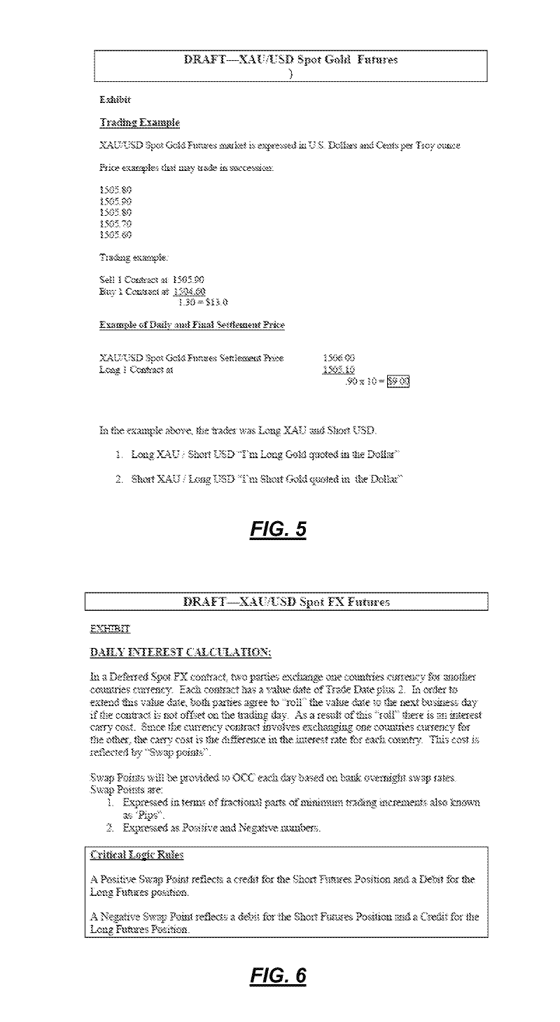

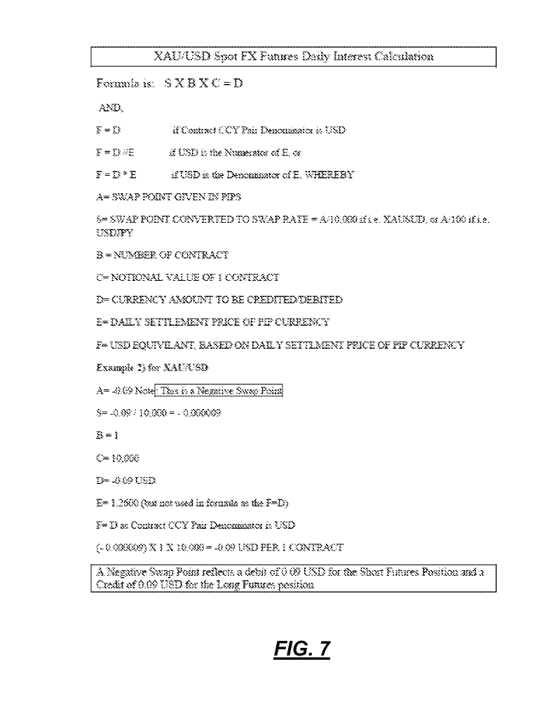

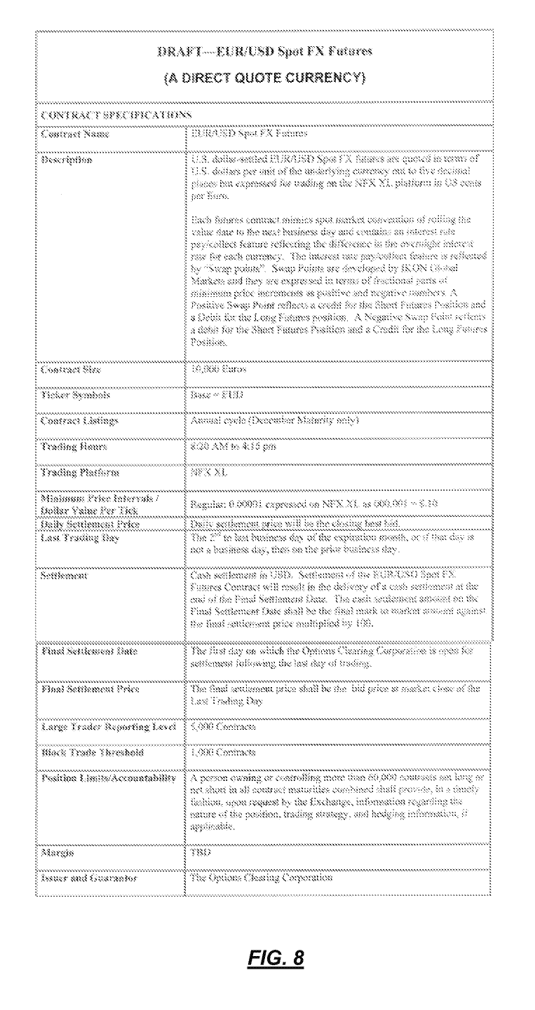

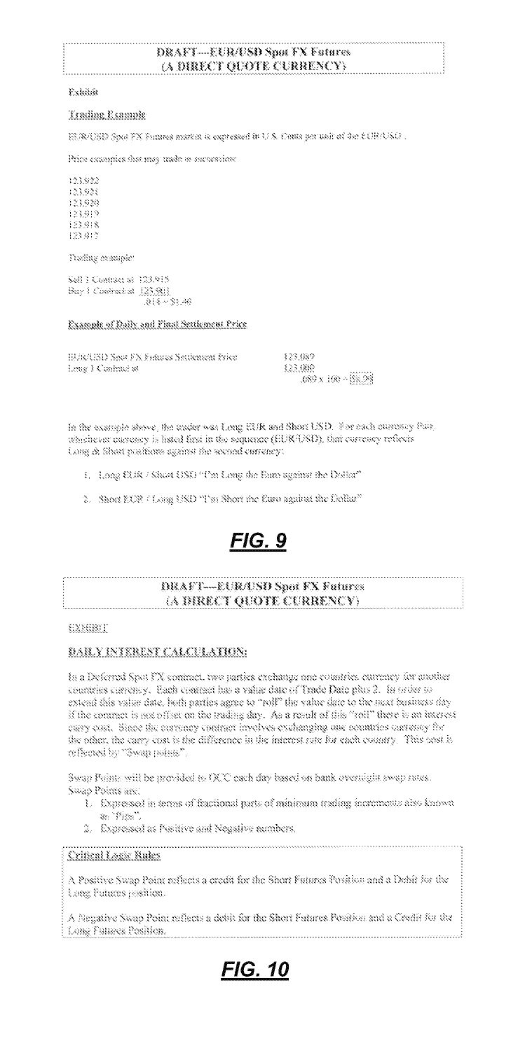

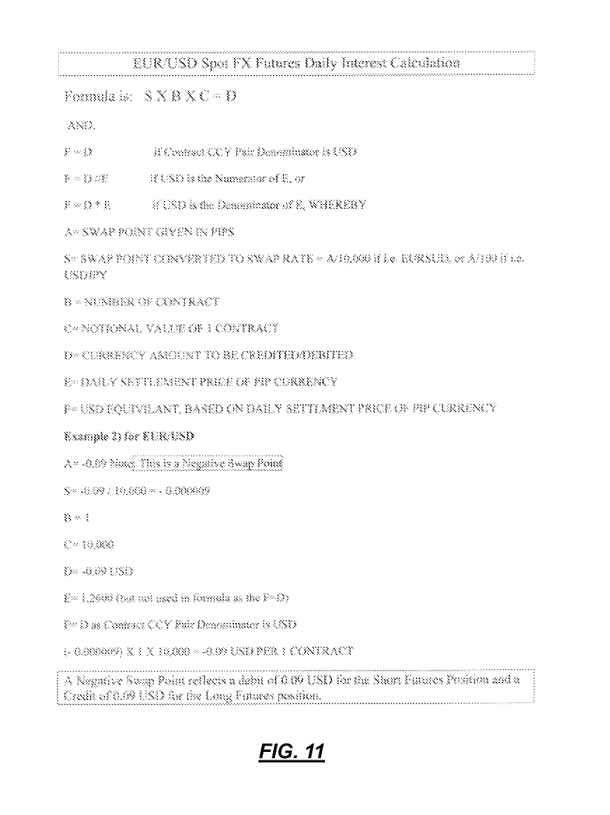

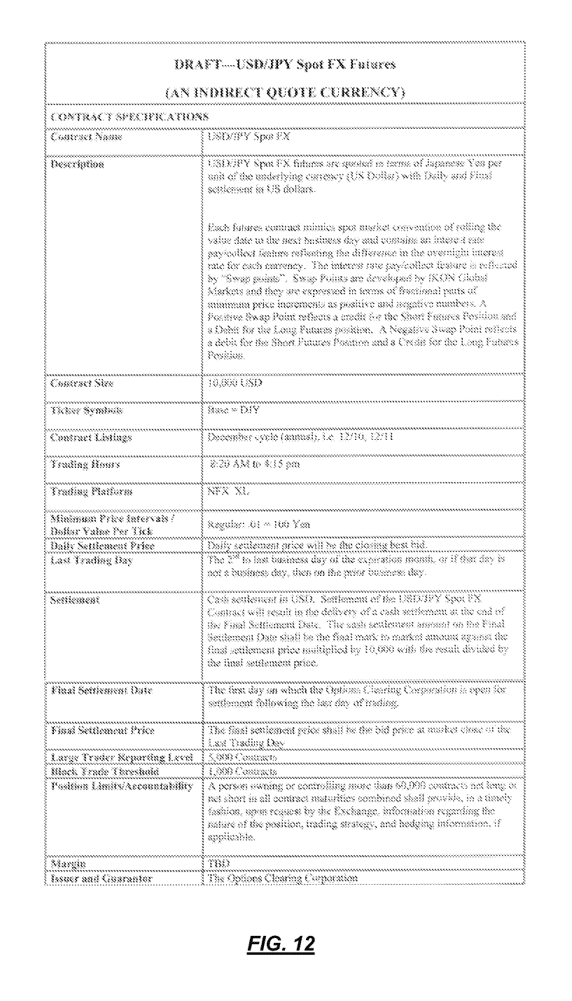

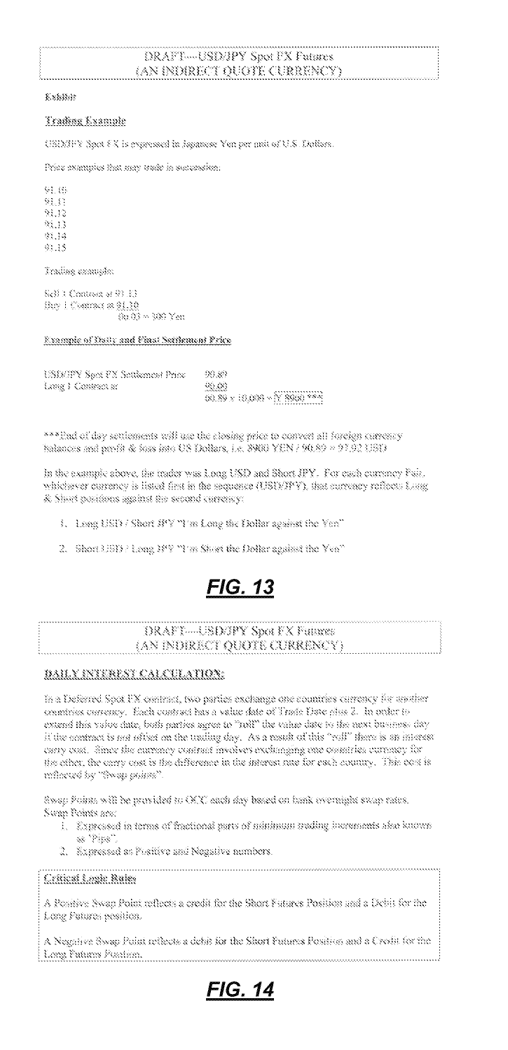

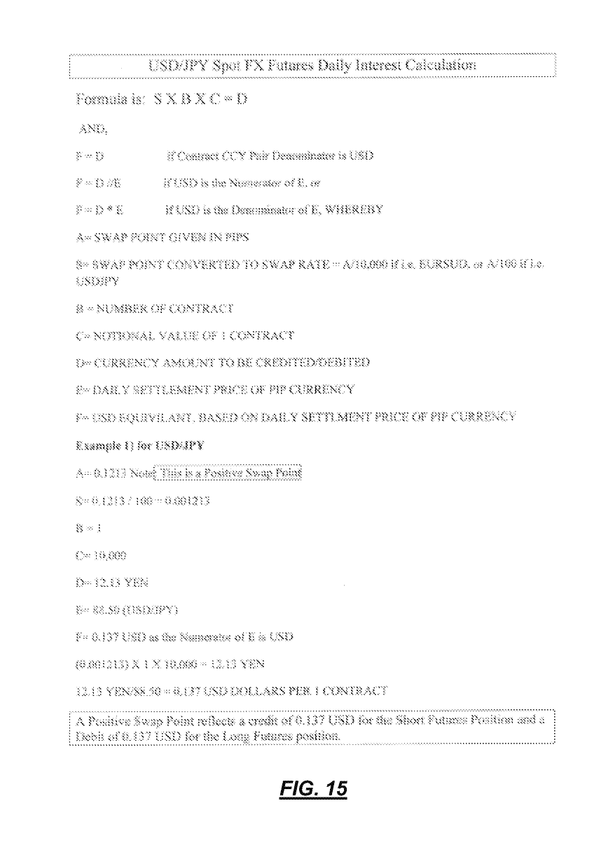

Referring now to FIGS. 4-14, examples of contract specifications, trading examples, interest calculation, and interest rate algorithm examples to be used with the methods and systems of the present application are shown. The XAU/USD Spot Gold Futures Product and EURO/USD Spot FX Product (“the Products”) allow traders to trade the spot market in the form of a Future. In the current OTC spot gold market, a trader takes a long or short position in gold at the same time that he takes the opposite position in the US dollar. It is similar to FX trading when the trader simultaneously buys one currency and sells another. Forex prices are quoted in pairs, such as EUR/USD, or the like. A spot gold quote is similar to reading a forex quote, and is represented the same way (e.g., XAU/USD). The first symbol listed represents one “troy” ounce of gold. So the price quote which may look something like 800 XAU/USD—simply means that one ounce of gold is equal to $800 U.S. dollars. Both of these Products shown are Futures with the integrity of the OTC spot market, which is uniquely achieved by retaining the market convention of rolling the value date to the next business day on open positions in a manner consistent with the method outlined in the Contract Specifications.

Thus, the financial product can include an interest rate pay/collect feature by way of Swap Points, which are expressed in terms of fractional parts of minimum price increments as positive and negative numbers, which reflect debits and credits for the long and short positions accordingly and wherein a Positive Swap Point reflects a credit for the Short Futures Position and a Debit for the Long Futures position, and a Negative Swap Point reflects a debit for the Short Futures Position and a Credit for the Long Futures Position.

While XAU/USD Spot Gold Futures, EUR/USD Spot FX Futures, and USD/JPY Spot FX Futures are disclosed, it is contemplated that the methods and systems of the present application can be used in other listed currency denominated contracts, other market opportunities, or the like.

Many modifications and variations of the present disclosure are possible in light of the above teachings. Therefore, within the scope of the appended claim, the present disclosure may be practiced other than as specifically described.

What is claimed is:

1. A computer implemented method of creating and trading a financial product, the method comprising the steps of:
requesting an order by first party for a first financial product from a second party, wherein the order is entered into a electronic computer trading system;
creating an agreement by the second party with a third party to convert the first financial product into a second financial product;
converting the first financial product into the second financial product;
clearing the second financial product;
delivering the cleared second financial product to the second party; and
listing the second financials product on an exchange; and
trading the second financial product on the exchange.

2. The computer-implemented method of claim 1, wherein the first financial product is a spot foreign exchange order.

3. The computer-implemented method of claim 1, wherein the second financial product is a futures contract.

4. The computer-implemented method of claim 1, wherein the second financial product is a foreign exchange deferred spot product.

5. The computer-implemented method of claim 1, wherein the first financial product is converted into the second financial product by an exchange of futures swaps.

6. The computer-implemented method of claim 1, wherein the second financial product is listed on a national exchange where it maintains a unique trading symbol and is traded by investors.

7. The computer-implemented method of claim 1, wherein the first party is at least one of a customer and retail investor.

8. The computer-implemented method of claim 1, wherein the second party is at least one of a futures commission merchant, a forex deal merchant, and a bank.

9. The computer-implemented method of claim 1, wherein the third party is at least one of an exchange and national exchange.

10. The computer-implemented method of claim 1, wherein the second financial product is cleared by at one of a third party acting as a clearing house, a clearing house owned by the third party; and wherein a fourth party that is the clearing house.

11. The computer-implemented method of claim 1, wherein the third party converts the first financial product into the second financial product, clears the second financial product, and delivers the cleared second financial product to the second party.

12. The computer-implemented method of claim 1, wherein a fourth party clears the second financial product and delivers the cleared second financial product to the second party.

13. The computer-implemented method of claim 1, wherein at least one of the steps are performed over a computer network.

14. A computerized method for creating and facilitating the trading of a financial product, the method comprising the steps of:
providing a computer server on which a financial product is selectively created and traded;
providing a computer interface in operable communication with the computer server, the computer interface enabling a user to enter an order for a financial product;
wherein a customer enters a foreign exchange order into the computer server;
wherein a futures commission merchant enters into an agreement with a national exchange which permits the foreign exchange order to be converted into a futures contract via an exchange of futures for swap;
wherein the foreign exchange order is converted into a futures contract via an exchange of futures for swap;
wherein the futures contract is cleared through a national clearing house; and
wherein the national clearing house delivers the cleared futures contract to the futures commission merchant and the futures commission merchant lists the futures contract on a national exchange where it maintains a unique trading symbol and can be traded by investors.

15. A computer system for creating and facilitating the trading of a financial product, the system comprising:
a computer server on which a financial product is selectively created and traded;
a computer interface in operable communication with the computer server, the computer interface enabling a user to enter an order for a financial product;
wherein the computer system enables a customer to enter a foreign exchange order into the computer server;
wherein the computer system enables a futures commission merchant to enter into an agreement with a national exchange which permits the foreign exchange order to be converted into a futures contract via an exchange of futures for swap;
wherein the computer system enables the foreign exchange order to be converted into a futures contract via an exchange of futures for swap;
wherein the computer system enables the futures contract to be cleared through a national clearing house; and
wherein computer system enables the national clearing house to deliver the cleared futures contract to the futures commission merchant and the futures commission merchant lists the futures contract on a national exchange where it maintains a unique trading symbol and can be traded by investors.
